(19) United States
(12) Patent Application Publication
(10) Pub. No.: US 2026/0166978 A1
(43) Pub. Date: Jun. 18, 2026

(54) ENERGY STORAGE DEVICE AND VEHICLE

(71) Applicant: TOYOTA JIDOSHA KABUSHIKI KAISHA, Toyota-shi (JP)

(72) Inventor: Nobuyasu NISHIKI, Toyokawa-shi (JP)

(73) Assignee: TOYOTA JIDOSHA KABUSHIKI KAISHA, Toyota-shi (JP)

(21) Appl. No.: 19/353,970

(22) Filed: Oct. 9, 2025

(30) Foreign Application Priority Data
Dec. 12, 2024 (JP) 2024-217498

(51) Int. Cl. B60K 1/04; B60L 50/64; H01G 11/78; H01M 50/242; H01M 50/249

(52) U.S. Cl. CPC B60K 1/04; B60L 50/64; H01M 50/242; H01M 50/249; B60K 2001/0438; H01G 11/78; H01M 2220/20

(57) ABSTRACT

In an energy storage device, a reinforcing member is disposed between an energy storage module and an electrical device. An intermediate member is disposed between the energy storage module and the electrical device. The intermediate member is disposed between an upper plate and the reinforcing member. An electrical connection member electrically connects the energy storage module and the electrical device. A holding member includes a retaining portion and a holding portion. The retaining portion is disposed between the upper plate and the intermediate member. The retaining portion retains the intermediate member. The holding portion holds the electrical connection member. The holding portion is in contact with the intermediate member in a horizontal direction.

### CROSS-REFERENCE TO RELATED APPLICATION

This application claims priority to Japanese Patent Application No. 2024-217498 filed on Dec. 12, 2024. The disclosure of the above-identified application, including the specification, drawings, and claims, is incorporated by reference herein in its entirety.

### BACKGROUND

### 1. Technical Field

The present disclosure relates to energy storage devices and vehicles.

### 2. Description of Related Art

Japanese Unexamined Patent Application Publication No. 2023-046945 (JP 2023-046945 A) discloses a battery pack. The battery case that serves as the outer shell of the battery pack is composed of an upper case and a lower case. Upper cross members are attached to an upper surface of the lower case. Each of the upper cross members is disposed in a corresponding one of the gaps between adjacent battery modules. Each intermediate mount is disposed in a corresponding one of the gaps between adjacent battery modules inside the battery case. Each intermediate mount is supported by a top portion of a corresponding one of the upper cross members and extends upward through the corresponding gap between the adjacent battery modules.

### SUMMARY

For example, in an energy storage device such as a battery pack, an electrical device may also be disposed inside the case. The electrical device and an energy storage module are electrically connected to each other via an electrical connection member. In this case, when an intermediate mount (intermediate member) is also disposed between the electrical device and the energy storage module, it becomes necessary to increase the size of the case in order to secure a space for installation of the electrical connection member. Alternatively, the structure of the intermediate member may be redesigned to facilitate the installation of the electrical connection member. However, such redesign increases the structural complexity of the intermediate member.

The present disclosure has been made in view of the above issues, and an object thereof is to provide an energy storage device in which an electrical connection member is installed inside a case, while suppressing both an increase in size of the case and an increase in structural complexity of an intermediate mount.

An energy storage device according to one aspect of the present disclosure includes a case, an energy storage module, an electrical device, a reinforcing member, an intermediate member, an electrical connection member, and a holding member. The case includes an upper plate and a lower plate. The lower plate is disposed below the upper plate. The energy storage module and the electrical device are disposed between the upper plate and the lower plate. The reinforcing member is disposed between the energy storage module and the electrical device. The reinforcing member is disposed between the upper plate and the lower plate. The intermediate member is disposed between the energy storage module and the electrical device. The intermediate member is disposed between the upper plate and the reinforcing member. The electrical connection member electrically connects the energy storage module and the electrical device. The holding member includes a retaining portion and a holding portion. The retaining portion is disposed between the upper plate and the intermediate member. The retaining portion retains the intermediate member. The holding portion holds the electrical connection member. The holding portion is in contact with the intermediate member in a horizontal direction.

According to the present disclosure, the electrical connection member can be installed inside the case while suppressing both an increase in size of the case and an increase in structural complexity of the intermediate member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a partial sectional view showing a vehicle according to an embodiment;

FIG. 2 is a plan view showing an energy storage device mounted in the vehicle according to the embodiment;

FIG. 3 is a partial perspective view showing an electrical connection member and a holding member of the energy storage device according to the embodiment; and

FIG. 4 is a partial perspective view showing a modification of the electrical connection member and the holding member.

### DETAILED DESCRIPTION OF EMBODIMENTS

Hereinafter, a vehicle and an energy storage device according to an embodiment of the present disclosure will be described with reference to the drawings. The same or corresponding portions are denoted by the same signs throughout the drawings, and description thereof will not be repeated. In the figures, “U” indicates the upward direction, “D” the downward direction, “F” the forward direction, “B” the rearward direction, “L” the leftward direction, and “R” the rightward direction. The vehicle width direction is a direction along both the rightward and leftward directions. The front-rear direction of the vehicle is a direction along both the forward and rearward directions. The horizontal direction is a direction substantially perpendicular to the up-down direction.

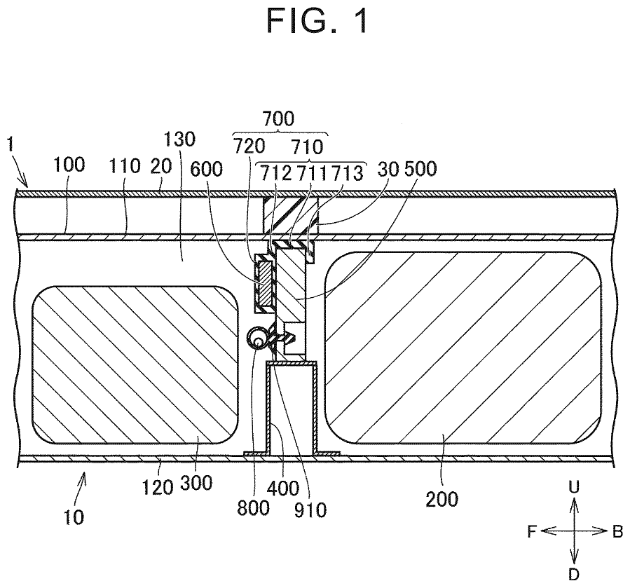

FIG. 1 is a partial sectional view showing a vehicle according to an embodiment. A vehicle 1 according to the embodiment of the present disclosure includes an energy storage device 10. The vehicle 1 may be a hybrid electric vehicle configured to travel using motive power from either or both of a motor and an engine powered by the electrical energy of the energy storage device 10, or an electrified vehicle configured to travel using driving force obtained from the electrical energy of the energy storage device 10.

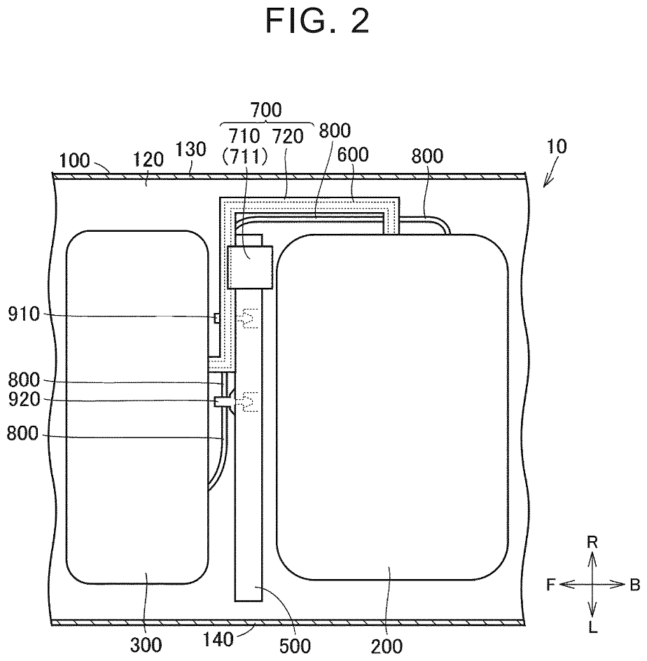

The energy storage device 10 will now be described. FIG. 2 is a plan view showing the energy storage device mounted in the vehicle according to the embodiment. As shown in FIGS. 1 and 2, the energy storage device 10 according to the embodiment of the present disclosure includes a case 100, an energy storage module 200, an electrical device 300, a reinforcing member 400, an intermediate member 500, an electrical connection member 600, a holding member 700, an electrical wire 800, a first support member 910, and a second support member 920.

The case 100 includes an upper plate 110, a lower plate 120, a first side wall 130, and a second side wall 140. For ease of description, the upper plate 110 is not shown in FIG. 2.

The upper plate 110 and the lower plate 120 extend in the horizontal direction. The lower plate 120 is disposed below the upper plate 110. The first side wall 130 and the second side wall 140 are arranged in the vehicle width direction. The upper plate 110, the lower plate 120, the first side wall 130, and the second side wall 140 form the internal space of the case 100.

In the present embodiment, the case 100 may include an upper case and a lower case that are connected together. The upper case may have a generally box-shaped configuration that is open at the bottom. In this case, the upper case may include the upper plate 110, an upper portion of the first side wall 130, and an upper portion of the second side wall 140. The lower case may have a generally box-shaped configuration that is open at the top. In this case, the lower case may include the lower plate 120, a lower portion of the first side wall 130, and a lower portion of the second side wall 140. The upper plate 110 may also serve as a floor panel that defines the cabin space of the vehicle 1.

The energy storage module 200 may include a plurality of energy storage cells. The energy storage cells may be, for example, secondary cells such as nickel metal hydride cells or lithium-ion cells. Each of the energy storage cells may be a cell using a liquid electrolyte or a cell using a solid electrolyte. Each of the energy storage cells may be a rechargeable capacitor.

The energy storage module 200 is disposed between the upper plate 110 and the lower plate 120. The energy storage module 200 is disposed between the first side wall 130 and the second side wall 140.

The electrical device 300 includes, for example, an electronic device such as a battery electronic control unit (ECU), and a junction box. The electrical device 300 is disposed between the upper plate 110 and the lower plate 120. The electrical device 300 is disposed between the first side wall 130 and the second side wall 140. The electrical device 300 is housed within the internal space of the case 100. The electrical device 300 is positioned in front of the energy storage module 200.

The reinforcing member 400 is made of, for example, a steel plate. The reinforcing member 400 has a hollow structure. The reinforcing member 400 may extend in the vehicle width direction. With this configuration, the reinforcing member 400 can suppress deformation of the case 100 when vibration occurs in the energy storage device 10 and the vehicle 1 equipped with the energy storage device 10. Moreover, the reinforcing member 400 can support either the first side wall 130 or the second side wall 140 when the vehicle 1 is involved in a side collision.

The reinforcing member 400 is disposed between the energy storage module 200 and the electrical device 300. More specifically, the reinforcing member 400 is positioned in front of the energy storage module 200. The reinforcing member 400 is positioned behind the electrical device 300.

The reinforcing member 400 is disposed between the upper plate 110 and the lower plate 120. The reinforcing member 400 is in contact with the lower plate 120 in the up-down direction. The reinforcing member 400 is fixed to the lower plate 120 by welding, a fastener, etc. The reinforcing member 400 is housed within the internal space of the case 100.

The intermediate member 500 is made of resin. The intermediate member 500 is disposed between the energy storage module 200 and the electrical device 300. The intermediate member 500 is positioned in front of the energy storage module 200. The intermediate member 500 is positioned behind the electrical device 300.

The intermediate member 500 is disposed between the upper plate 110 and the reinforcing member 400. The intermediate member 500 is housed within the internal space of the case 100. The intermediate member 500 extends in the vehicle width direction. The intermediate member 500 is in contact with the reinforcing member 400 in the up-down direction. The intermediate member 500 is fixed to the reinforcing member 400 by welding, a fastener, etc.

The electrical connection member 600 electrically connects the energy storage module 200 and the electrical device 300. The electrical connection member 600 is made of metal. The electrical connection member 600 may be a busbar capable of withstanding relatively high voltages. The electrical connection member 600 may be electrically connected to the junction box of the electrical device 300.

The electrical connection member 600 extends from the electrical device 300 in the space between the electrical device 300 and the intermediate member 500. As viewed in the up-down direction, the electrical connection member 600 passes between the intermediate member 500 and the first side wall 130.

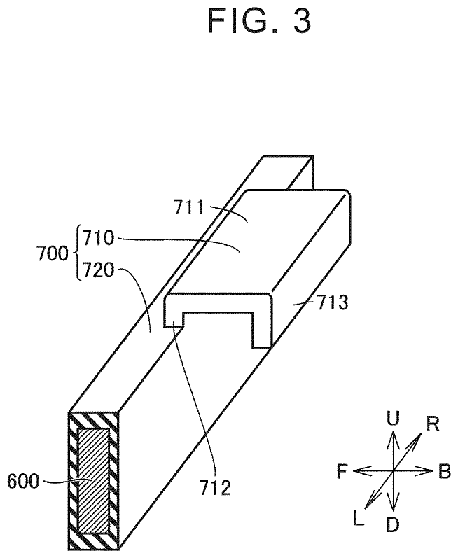

FIG. 3 is a partial perspective view showing the electrical connection member and the holding member of the energy storage device according to the present embodiment. As shown in FIGS. 1 to 3, the holding member 700 includes a retaining portion 710 and a holding portion 720.

The retaining portion 710 is disposed between the upper plate 110 and the intermediate member 500. The retaining portion 710 is in contact with the intermediate member 500 and the upper plate 110 in the up-down direction. The retaining portion 710 retains the intermediate member 500.

The retaining portion 710 may be electrically insulating. Specifically, the retaining portion 710 includes an upper wall 711, a first wall 712, and a second wall 713. The upper wall 711 is disposed between the upper plate 110 and the intermediate member 500. The upper wall 711 is in contact with the intermediate member 500 and the upper plate 110 in the up-down direction. The first wall 712 extends downward from the upper wall 711. The first wall 712 is in contact with the intermediate member 500 on the side facing the electrical device 300. The second wall 713 extends downward from the upper wall 711. The second wall 713 is in contact with the intermediate member 500 on the side facing the energy storage module 200.

The holding portion 720 is electrically insulating. The holding portion 720 may be molded integrally with the retaining portion 710. The holding portion 720 holds the electrical connection member 600. The holding portion 720 covers the electrical connection member 600 along its entire length from the energy storage module 200 to the electrical device 300. The holding portion 720 is in contact with the intermediate member 500 in the horizontal direction.

The holding portion 720 is disposed between the intermediate member 500 and the electrical device 300. The holding portion 720 is connected to the retaining portion 710. In the present embodiment, the holding portion 720 is connected to the underside of the first wall 712. The holding portion 720 may be formed integrally with the retaining portion 710.

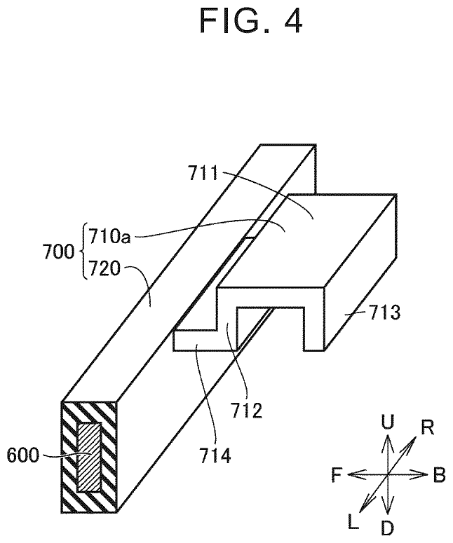

The shape of the holding member 700 is not limited to that described above. FIG. 4 is a partial perspective view showing a modification of the electrical connection member and the holding member. As shown in FIG. 4, a retaining portion 710a may further include an extension portion 714. The extension portion 714 extends horizontally from the first wall 712. The holding portion 720 may be connected to the extension portion 714 at a side surface facing the horizontal direction.

As shown in FIGS. 1 and 2, the electrical wire 800 connects the energy storage module 200 and the electrical device 300. The electrical wire 800 may be, for example, a cable for communication between the electrical device 300 (such as the battery ECU included in the electrical device 300) and the energy storage module 200. Specifically, the electrical wire 800 may be a wire harness.

The electrical wire 800 extends from the electrical device 300 in the space between the electrical device 300 and the intermediate member 500. As viewed in the up-down direction, the electrical wire 800 passes between the intermediate member 500 and the first side wall 130.

The first support member 910 supports the electrical wire 800 via a clamp mechanism. The first support member 910 is attached to the intermediate member 500 below the holding portion 720. The first support member 910 is disposed between the intermediate member 500 and the electrical device 300.

The second support member 920 supports the electrical wire 800 via a clamping mechanism. The second support member 920 is attached to the intermediate member 500 so as not to overlap with the holding member 700 in the up-down direction. The second support member 920 is disposed between the intermediate member 500 and the electrical device 300.

Other components of the vehicle 1 will now be described. As shown in FIG. 1, the vehicle 1 further includes a floor panel 20 and a cushioning member 30.

The floor panel 20 may be part of the body of the vehicle 1. The floor panel 20 may be a member that defines the cabin space of the vehicle. The floor panel 20 is disposed above the upper plate 110. The cushioning member 30 is located above the retaining portion 710 and is sandwiched between the upper plate 110 and the floor panel 20.

As described above, the energy storage device 10 according to the embodiment of the present disclosure includes the case 100, the energy storage module 200, the electrical device 300, the reinforcing member 400, the intermediate member 500, the electrical connection member 600, and the holding member 700. The case 100 includes the upper plate 110 and the lower plate 120. The lower plate 120 is disposed below the upper plate 110. The energy storage module 200 and the electrical device 300 are disposed between the upper plate 110 and the lower plate 120. The reinforcing member 400 is disposed between the energy storage module 200 and the electrical device 300. The reinforcing member 400 is disposed between the upper plate 110 and the lower plate 120. The intermediate member 500 is disposed between the energy storage module 200 and the electrical device 300. The intermediate member 500 is disposed between the upper plate 110 and the reinforcing member 400. The electrical connection member 600 electrically connects the energy storage module 200 and the electrical device 300. The holding member 700 includes the retaining portion 710 and the holding portion 720. The retaining portion 710 is disposed between the upper plate 110 and the intermediate member 500. The retaining portion 710 retains the intermediate member 500. The holding portion 720 holds the electrical connection member 600. The holding portion 720 is in contact with the intermediate member 500 in the horizontal direction.

With the above configuration, the electrical connection member 600 can be easily disposed inside the case 100 without increasing the structural complexity of the intermediate member 500, for example, without embedding the electrical connection member 600 inside the intermediate member 500. In addition, since a gap is less likely to be formed between the holding portion 720 and the intermediate member 500, it is possible to suppress an increase in size of the case 100 for installation of the electrical connection member 600.

In other words, with the configuration described above, the electrical connection member 600 can be installed inside the case 100 while suppressing both an increase in size of the case 100 and an increase in structural complexity of the intermediate member 500.

In the present embodiment, the holding portion 720 is disposed between the intermediate member 500 and the electrical device 300.

With the above configuration, when the energy storage module 200 enters an abnormal mode and emits smoke, the intermediate member 500 serves as a barrier, thereby making it less likely for the smoke to reach the holding portion 720 and the electrical connection member 600 that are located between the intermediate member 500 and the electrical device 300.

The energy storage device 10 according to the present embodiment further includes the electrical wire 800 and the first support member 910. The electrical wire 800 connects the energy storage module 200 and the electrical device 300. The first support member 910 supports the electrical wire 800. The first support member 910 is attached to the intermediate member 500 below the holding portion 720.

Because the first support member 910 is attached as described above, the overall dimension of the intermediate member 500, the holding portion 720, and the first support member 910 in the horizontal direction is reduced, allowing the internal space of the case 100 to be used more efficiently.

In the present embodiment, the first support member 910 is disposed between the intermediate member 500 and the electrical device 300.

With the above configuration, when the energy storage module 200 enters an abnormal mode and emits smoke, the intermediate member 500 serves as a barrier, thereby making it less likely for the smoke to reach the first support member 910 and the electrical wire 800 that are located between the intermediate member 500 and the electrical device 300.

In the present embodiment, the reinforcing member 400 is in contact with the lower plate 120 in the up-down direction. The intermediate member 500 is in contact with the reinforcing member 400 in the up-down direction. The retaining portion 710 is in contact with the intermediate member 500 and the upper plate 110 in the up-down direction.

With the above configuration, when vibration occurs in the energy storage device 10, the reinforcing member 400, the intermediate member 500, and the retaining portion 710 support the upper plate 110 and the lower plate 120, thereby suppressing deformation of the case 100. Furthermore, because the retaining portion 710 of the holding member 700 supports the upper plate 110 and the lower plate 120 as described above, the holding portion 720 of the holding member 700 suppresses movement of the electrical connection member 600 relative to the case 100 during the vibration.

The energy storage device 10 according to the present embodiment further includes the second support member 920. The second support member 920 supports the electrical wire 800. The second support member 920 is attached to the intermediate member 500 so as not to overlap with the holding member 700 in the up-down direction.

With the above configuration, the second support member 920 can be easily assembled to the intermediate member 500 to which the holding member 700 is already attached. Because the overall dimension of the intermediate member 500, the holding portion 720, and the second support member 920 in the horizontal direction is reduced, the internal space of the case 100 can be used more efficiently.

In the present embodiment, the second support member 920 is disposed between the intermediate member 500 and the electrical device 300.

With the above configuration, when the energy storage module 200 enters an abnormal mode and emits smoke, the intermediate member 500 serves as a barrier, thereby making it less likely for the smoke to reach the second support member 920 located between the intermediate member 500 and the electrical device 300.

The vehicle 1 according to the present embodiment also includes the energy storage device 10, the floor panel 20, and the cushioning member 30. The floor panel 20 is disposed above the upper plate 110. The cushioning member 30 is located above the retaining portion 710 and is sandwiched between the upper plate 110 and the floor panel 20.

With the above configuration, when the floor panel 20 attempts to deform downward, the retaining portion 710 can suppress such deformation via the cushioning member 30 and the upper plate 110. Furthermore, because the retaining portion 710 receives the load from the floor panel 20, the load is less likely to be transmitted to the electrical connection member 600 via the holding portion 720. As a result, the electrical connection member 600 is less likely to move within the case 100.

In the above-described embodiment, configurations that can be combined may be used in combination.

The embodiment disclosed herein should be considered to be illustrative in all respects and not restrictive. The scope of the present disclosure is defined by the claims rather than by the above description, and is intended to include all modifications within the meaning and scope equivalent to the claims.

What is claimed is:

1. An energy storage device comprising:
a case;
an energy storage module;
an electrical device;
a reinforcing member;
an intermediate member;
an electrical connection member; and
a holding member, wherein:
the case includes an upper plate and a lower plate;
the lower plate is disposed below the upper plate;
the energy storage module and the electrical device are disposed between the upper plate and the lower plate;
the reinforcing member is disposed between the energy storage module and the electrical device;
the reinforcing member is disposed between the upper plate and the lower plate;
the intermediate member is disposed between the energy storage module and the electrical device;
the intermediate member is disposed between the upper plate and the reinforcing member;
the electrical connection member electrically connects the energy storage module and the electrical device;
the holding member includes a retaining portion and a holding portion;
the retaining portion is disposed between the upper plate and the intermediate member;
the retaining portion retains the intermediate member;
the holding portion holds the electrical connection member; and
the holding portion is in contact with the intermediate member in a horizontal direction.

2. The energy storage device according to claim 1, wherein the holding portion is disposed between the intermediate member and the electrical device.

3. The energy storage device according to claim 1, further comprising:
an electrical wire; and
a first support member, wherein:
the electrical wire connects the energy storage module and the electrical device;
the first support member supports the electrical wire; and
the first support member is attached to the intermediate member below the holding portion.

4. The energy storage device according to claim 3, wherein the holding portion and the first support member are disposed between the intermediate member and the electrical device.

5. A vehicle comprising:
the energy storage device according to claim 4;
a floor panel; and
a cushioning member, wherein:
the energy storage device further includes a second support member;
the case further includes a first side wall and a second side wall;
the first side wall and the second side wall are arranged in a vehicle width direction;
the energy storage module and the electrical device are disposed between the first side wall and the second side wall;
the reinforcing member is in contact with the lower plate in an up-down direction;
the intermediate member extends in the vehicle width direction;
the intermediate member is in contact with the reinforcing member in the up-down direction;
as viewed in the up-down direction, the electrical connection member passes between the intermediate member and the first side wall;
the retaining portion is in contact with the intermediate member and the upper plate in the up-down direction;
the holding portion is electrically insulating;
the holding portion covers the electrical connection member along an entire length of the electrical connection member from the energy storage module to the electrical device;
the second support member supports the electrical wire;
the second support member is attached to the intermediate member so as not to overlap with the holding member in the up-down direction;
the second support member is disposed between the intermediate member and the electrical device;
the floor panel is disposed above the upper plate; and
the cushioning member is located above the retaining portion and is sandwiched between the upper plate and the floor panel.
